(19) United States
(12) Patent Application Publication
(10) Pub. No.: US 2003/0070898 A1
(43) Pub. Date: Apr. 17, 2003

(54) 3-D misalignment isolator bearing

(76) Inventors: Eugene Wolbers, Northville, MI (US); David L. Ziemba, Macomb Twp., MI (US)

Correspondence Address: Steven L. Oberholtzer, BRINKS HOFER GILSON & LIONE, P.O. Box 10395, Chicago, IL, 60610, US

(21) Appl. No.: 09/975,492

(22) Filed: Oct. 11, 2001

(51) Int. Cl. F16D 23/14

(52) U.S. Cl. 192/98; 192/110 B; 384/612

(57) ABSTRACT

A clutch release bearing assembly includes a bearing carrier with a central axis. A bearing assembly, supported on the bearing carrier, includes a stationary race, a rotatable race and a plurality of anti-friction elements disposed therebetween. An aligning ring having a radial outer diameter and a front face is mounted to the rotatable race and is adapted for engagement with a spring plate of a clutch assembly. The bearing assembly is mounted to the bearing carrier to allow limited radial shifting of the bearing with respect to the bearing carrier. The front face of the aligning ring defines a plane that is normal to the axis of the bearing carrier, and the aligning ring and the bearing are mounted to the bearing carrier to allow limited angular displacement of the front face away from normal relative to the central axis of the bearing carrier.

### TECHNICAL FIELD OF THE INVENTION

The present invention generally relates to a self aligning bearing for an automotive manual clutch release assembly.

### BACKGROUND OF THE INVENTION

In an automotive manual transmission clutch assembly a clutch plate is clamped against the flywheel of the engine by a spring plate and is connected to the input shaft of the transmission. When the clutch pedal is pushed in, a cable pulls on a release fork, which pushes or pulls a clutch release bearing, or throw-out bearing, against the middle of the spring plate. As the center of the spring plate is pushed in, the outer portion of the spring plate pivots to relieve clamping pressure exerted by the clutch plate and to unclamp the clutch plate from the flywheel of the engine. This disengages the engine from the transmission.

Minor alignment inaccuracies between the clutch release bearing and the spring plate inevitably occur, therefore, it is necessary for the clutch release bearing to be able to accommodate such slight positioning variations. Also, slight angular mis-alignment between the fingers of the spring plate and the clutch release bearing will put un-even pressure onto the clutch release bearing which will cause uneven or accelerated wear to the clutch release bearing. These mis-alignments between the clutch release bearing and the spring plate can also cause uneven loading which can cause higher pressure and increased stroke of the clutch pedal in order to fully release the clutch plate. Additionally, abnormalities due to slight mis-alignment as well as impulse forces and vibrations from the engine can be transferred through the clutch and the clutch release bearing and ultimately can be felt through the clutch pedal or heard by the operator of the vehicle.

Typically, in order to accommodate these slight mis-alignments tolerance must currently be built into the system. Other methods include placing rubber dampers in the clutch assembly, or adding mass to the lever that actuates the clutch release bearing. In hydraulic actuated clutch assemblies, a dampener can be placed in the hydraulic lines between the pedal and the clutch to absorb these impulses and vibrations.

In view of the foregoing, there is a need in the industry for a clutch release bearing that will accommodate radial and angular mis-alignment between the clutch release bearing and the spring plate and will isolate torsional, radial, and axial impulses and vibrations from the engine and prevent transmission of these impulses and vibrations from the clutch to the operator of the vehicle.

### SUMMARY OF THE INVENTION

In accordance with an aspect of the present invention, a self aligning clutch release bearing assembly includes a bearing carrier with a central axis, and a bearing supported on the bearing carrier. The bearing includes a stationary race, a rotatable race and rolling bearing elements disposed between them. An aligning ring is mounted to the rotatable race and includes a front face adapted for engagement with a spring plate of the clutch assembly. The bearing is mounted to the bearing carrier to allow limited radial shifting of the bearing with respect to the bearing carrier. The aligning ring and bearing are mounted to the bearing carrier to allow limited angular displacement of the front face away from normal relative to the central axis of the bearing carrier.

Different embodiments of the present invention include having a elastomeric ring or a hydraulic chamber disposed between the rotatable race and the aligning ring, providing corresponding spherical surfaces on the aligning ring and the rotatable race, or providing an elastomeric ring or a hydraulic chamber to support both the stationary and the rotatable race.

### BRIEF DESCRIPTION OF THE DRAWINGS

FIG. 1 is a side sectional view of a first embodiment of a clutch release bearing assembly of the present invention;

FIG. 2 is a schematic view of a representative clutch assembly using a pushing motion to disengage the clutch plate;

FIG. 3 is a schematic view of a clutch assembly using a pulling motion to disengage the clutch plate;

FIG. 4 is a side sectional view of the first embodiment shown with a two piece alignment ring;

FIG. 5 is a side sectional view of the first embodiment shown just prior to engagement with the fingers of a spring plate;

FIG. 6 is a side sectional view of the first embodiment shown in engagement with the fingers of the spring plate;

FIG. 7 is a side sectional view of a second embodiment of a clutch release bearing of the present invention;

FIG. 8 is a side sectional view of a third embodiment of a clutch release bearing of the present invention;

FIG. 9 is a side sectional view of the third embodiment shown with a two-piece aligning ring;

FIG. 10 is a side sectional view of the third embodiment shown with fingers of a spring plate prior to engagement;

FIG. 11 is a side sectional view of the third embodiment shown in engagement with the fingers of the spring plate;

FIG. 12 is a side sectional view of a fourth embodiment of the clutch release bearing of the present invention;

FIG. 13 is a side sectional view of the fourth embodiment of the present invention shown with an alternate aligning ring;

FIG. 14 is a side sectional view of the fourth embodiment shown with a fluid filled bladder;

FIG. 15 is a side sectional view of a fifth embodiment of a clutch release bearing of the present invention;

FIG. 16 is a side sectional view of a sixth embodiment of a clutch release bearing of the present invention;

FIG. 17 is a side sectional view of the sixth embodiment of the clutch release bearing of the present invention shown with an alternative aligning ring;

FIG. 18 is a side sectional view of a seventh embodiment of a clutch release bearing of the present invention.

FIG. 19 is a side sectional view of an eighth embodiment of a clutch release bearing of the present invention.

### DETAILED DESCRIPTION OF THE PREFERRED EMBODIMENT

The following description of the preferred embodiments of the invention is not intended to limit the scope of the invention to these preferred embodiments, but rather to enable any person skilled in the art to make and use the invention.

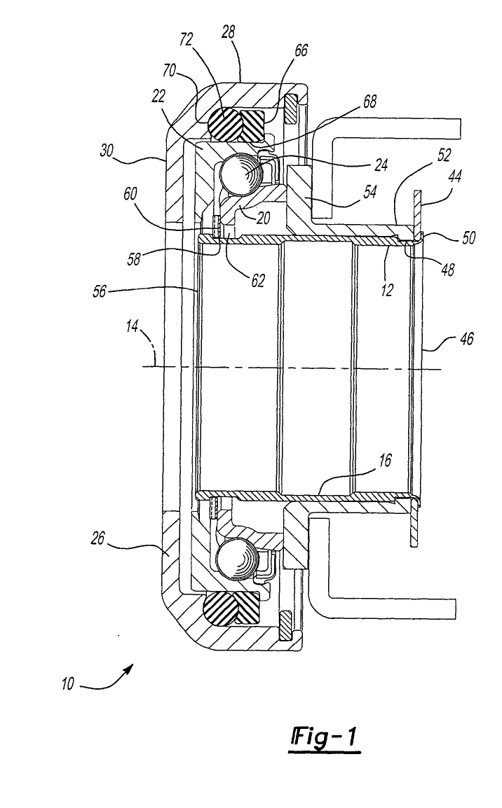

Referring to the Figures, wherein like numerals indicate like or corresponding parts throughout the several views and embodiments, a first preferred embodiment of the self aligning clutch release bearing assembly of the present invention is shown by FIGS. 1, 4, 5 & 6 and is designated by the reference number 10. Referring to FIG. 1, the self aligning clutch bearing 10 includes a bearing carrier 12 which defines a central axis 14. The bearing carrier 12 is a cylindrical tube that is preferably made from steel or nylon. The inner diameter of the bearing carrier 12 includes a grease groove 16 for retaining a lubricant. In operation, the clutch release bearing 10 slides back and forth on a stationary quill (not shown). The lubricant held within the grease groove 16 on the inner diameter of the bearing carrier 12 allows the bearing carrier 12 to slide smoothly along the quill.

A bearing is supported on the bearing carrier 12. The bearing can be any type of bearing used in the industry such as an angular contact bearing, a radial bearing, or a thrust bearing. The bearing includes a stationary race 20, a rotatable race 22 and a plurality of anti-friction elements 24 disposed between the stationary race 20 and the rotatable race 22 to support the rotatable race 22 and to allow rotational movement of the rotatable race 22 with respect to the stationary race 20. The stationary race 20 does not rotate with respect to the bearing carrier 12, therefore the rotatable race 22 rotates relative to the bearing carrier 12. An aligning ring 26 is mounted to the rotatable race 22. The aligning ring 26 includes a radial outer diameter 28 and a front face 30 that is adapted for engagement with a spring plate of a clutch assembly.

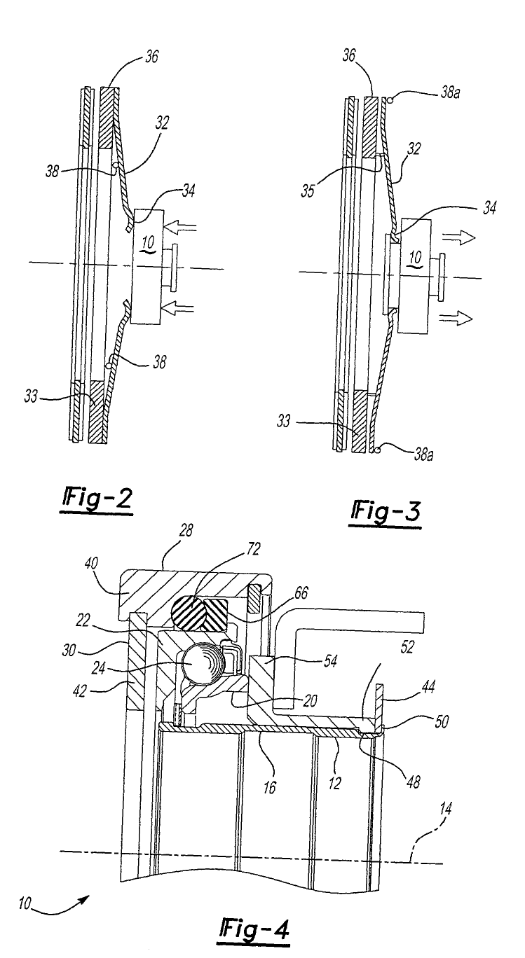

Referring to FIGS. 2 and 3, the spring plate 32 of the clutch can be actuated to release the clutch plate 33 either by pulling on the fingers of the spring plate 32 or by pushing on the fingers of the spring plate 32. The spring plate 32 can be mounted within the clutch in such a way that the clutch release bearing 10 contacts the spring plate 32 at the center 34 and the clutch plate 33 is connected to the spring plate 32 at the outer edge 36 of the spring plate 32. A pivot point 38 of the spring fingers is between the center 34 of the spring plate 32 and the connection between the spring plate 32 and the clutch plate 33. As shown in FIG. 2, when the center 34 of the spring plate 32 is pushed inward toward the clutch plate 33, the fingers pivot about the pivot point 38, and the outer edge 36 of the spring plate 32 moves in an opposite direction away from the clutch plate 33. The result is that the pressure exerted on the clutch plate 33 from the spring plate 32 is relieved.

Alternatively, the spring plate 32 can be mounted within the clutch in such a way that the clutch release bearing 10 contacts the spring plate 32 at the center 34 and the clutch plate 33 is connected to the spring plate 32 at a point 35 between the center 34 of the spring plate 32 and the outer edge 36 of the spring plate 32. The pivot point 38a of the spring fingers is at the outer edge 36 of the spring plate 32. As shown in FIG. 3, when the center 34 of the spring plate 32 is pulled outward away from the clutch plate 33, the connection 35 between the spring plate 32 and the clutch plate 33 moves outward away from the clutch plate 33 as well. The result is that the pressure exerted on the clutch plate 33 from the spring plate 32 is relieved.

The aligning ring 26 of the present invention can be adapted for either a push motion or a pull motion. As shown in FIG. 1, the aligning ring 26 presents a front face 30 that is perpendicular to the central axis 14 of the bearing carrier 12. In this embodiment, the aligning ring 26 will simply come into contact with the fingers of the spring plate 32, and is suitable for pushing the fingers of the spring plate 32 inward toward the clutch plate 33. However, it is to be understood that the aligning ring 26 could be modified to include features that would allow the front face 30 of the aligning ring 26 to attach to the fingers of the spring plate 32 in a manner suitable for pulling the fingers of the spring plate 32 outward away from the clutch plate 33.

Preferably the bearing is mounted to the bearing carrier 12 in a manner that will allow the bearing to shift radially with respect to the bearing carrier 12. In the first preferred embodiment, a washer 44 is affixed to a first end 46 of the bearing carrier 12. Preferably, the first end 46 of the bearing carrier 12 includes a step 48 onto which the washer 44 rests, and a distal edge 50 of the first end 46 of the bearing carrier 12 is rolled over to firmly attach the washer 44 thereto. A support sleeve 52 extends around the bearing carrier 12 and rests against the washer 44. The support sleeve 52 is preferably made from powdered metal, and includes an annular flange 54 extending around the support sleeve 52 opposite the washer 44. It is to be understood that the support sleeve 52 could be made from any other suitable material. A second end 56 of the bearing carrier 12, opposite the first end 46, includes a snap ring groove 58 extending radially around the outer diameter of the bearing carrier 12 for receiving a snap ring 60. The stationary race 20 of the bearing 18 is positioned between the snap ring 60 and the annular flange 54 of the support sleeve 52. Preferably, the snap ring 60 is a spring washer having a plurality of layers of a helically wound serpentine strip of resilient material. The spring washer provides axial force against the stationary race 20 to keep the stationary race 20 held tightly against the annular flange 54 of the support sleeve 52.

The stationary race 20 has an inner diameter that is larger than the outer diameter of the bearing carrier 12 leaving a gap 62 therebetween. This radial gap 62 between the inner diameter of the stationary race 20 and the outer diameter of the bearing carrier 12 provides a clearance to allow the stationary race 20 to shift radially relative to the bearing carrier 12. The amount of clearance between the inner diameter of the stationary race 20 and the outer diameter of the bearing carrier 12 determines how far the stationary race 20 can shift. The rotatable race 22 is rotatably connected to the stationary race 20, and the aligning ring 26 is attached to the rotatable race 22, therefore, the aligning ring 26 is allowed to shift radially relative to the bearing carrier 12 as the stationary race 20 shifts.

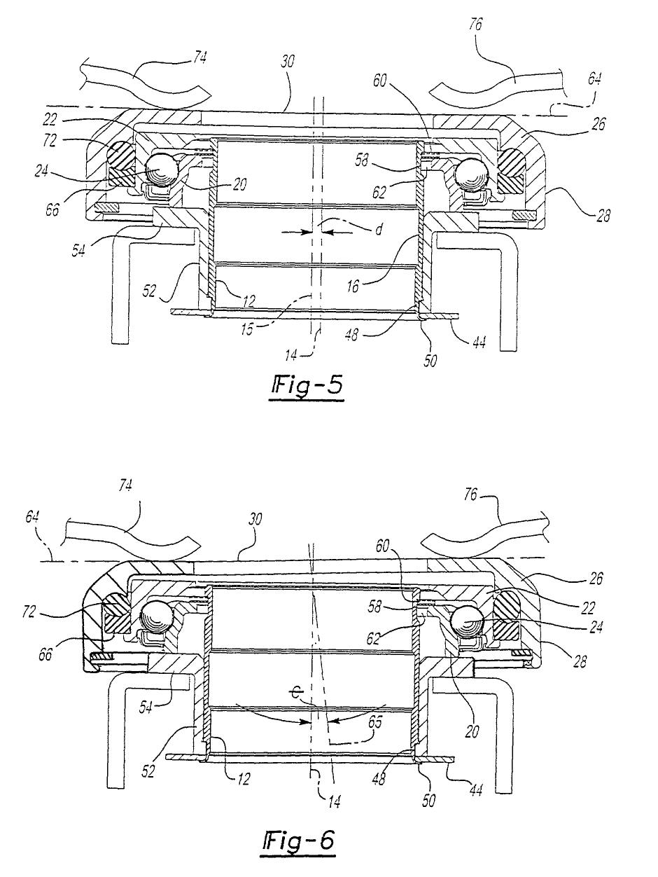

It is desirable to allow radial shifting of the aligning ring 26 relative to the bearing carrier 12 to accommodate for mis-alignment between the spring plate 32 of the clutch and the aligning ring 26 of the clutch release bearing 10 when the clutch release bearing 10 is assembled to the spring plate 32 of the clutch. Once assembled, radial shifting between the clutch release bearing 10 and the spring plate 32 is permitted. Referring to FIG. 5, a central axis 15 of the stationary race 20 can be offset a radial distance, d, from the central axis 14 of the bearing carrier 12. At the time of assembly, and for a short period thereafter there will be some radial adjusting as the components are broken in. Therefore, the radial shifting is allowed between the aligning ring 26 and the bearing carrier 12 to accommodate slight radial shifting without loading the clutch components.

The front face 30 of the aligning ring 26 defines a plane 64 that is normal to the central axis 14 of the bearing carrier 12. The aligning ring 26 and the bearing 18 are mounted to the bearing carrier 12 in such a way as to allow limited angular displacement of the front face 30 away from normal relative to the central axis 14 of the bearing carrier 12. In the first preferred embodiment, the rotatable race 22 includes a support ring 66 that can be either press fit or molded onto an outer diameter 68 of the rotatable race 22. The aligning ring 26 fits over the rotatable race 22. There is a clearance fit between the aligning ring 26 and the rotatable race 22. An inner surface of the aligning ring 26 includes a contoured contact surface 70, and an elastomeric device is placed between the contoured surface 70 of the aligning ring 26 and the support ring 66 of the rotatable race 22. Preferably, the elastomeric device is a solid o-ring 72 made from Nitrile or some other suitable elastomer. The o-ring 72 extends around the outer diameter of the rotatable race 22 and provides support for the aligning ring 26 thereon.

If uneven loading occurs on the front face 30 of the aligning ring 26, then the o-ring 72 will compress at the point of higher loading, and allow the front face 30 of the aligning ring 26 to displace angularly away from being perfectly perpendicular to the central axis 14 of the bearing carrier 12.

Additionally, the aligning ring 26 can be either one piece, as shown in FIG. 1, or two piece. A one piece aligning ring 26 can be made from either a polymeric plastic material such as Nylon or from steel. Referring to FIG. 4, a two piece aligning ring 26 can be made from steel and nylon. The two piece aligning ring 26 includes an outer ring portion 40, and a frontal portion 42. Preferably, the frontal portion 42 is made from steel, and the outer ring portion 40 is made from nylon. It is to be understood, that the outer ring portion 40 and the frontal portion 42 could be made from other suitable materials. Preferably, the outer ring portion 40 is molded onto the frontal portion 42, however, the frontal portion 42 and the outer ring portion 40 could be attached to each other by other methods such as press fitting the two components 40, 42 together.

Referring to FIG. 5, the aligning ring 26 is oriented at an initial position when there is no load present. The initial position is where the front face 30 of the aligning ring 26 is perpendicular to the central axis 14 of the bearing carrier 12. The aligning ring 26 is held at the initial position since when no load is present, the elatomeric o-ring 72 is not deformed and provides equal support around the entire aligning ring 26. However, when the aligning ring 26 comes into contact with an uneven spring plate 32, the o-ring 72 will compress at the point of higher loading to allow the aligning ring 26 to tilt, thereby evening out the load over the front face 30 of the aligning ring 26.

Referring to FIG. 6, a first finger 74 of the spring plate 32 contacts the front face 30 of the aligning ring 26 before a second finger 76. When the first finger 74 contacts, the portion of the o-ring 72 supporting the side of the aligning ring 26 that the first finger 74 comes into contact with compresses. The aligning rings 26 tilts so that a line 65 normal to the plane 64 of the front face 30 is angularly displaced from the central axis 14. The angular displacement, or angular mis-alignment, is designated as angle θ. After the second finger 76 has come into contact with the aligning ring 26, there is even loading over the entire surface of the front face 30 of the aligning ring 26. Even loading will help prevent vibrations and impulses from being transferred through the bearing, and will keep the loads on the bearing even, thereby increasing the life of the bearing.

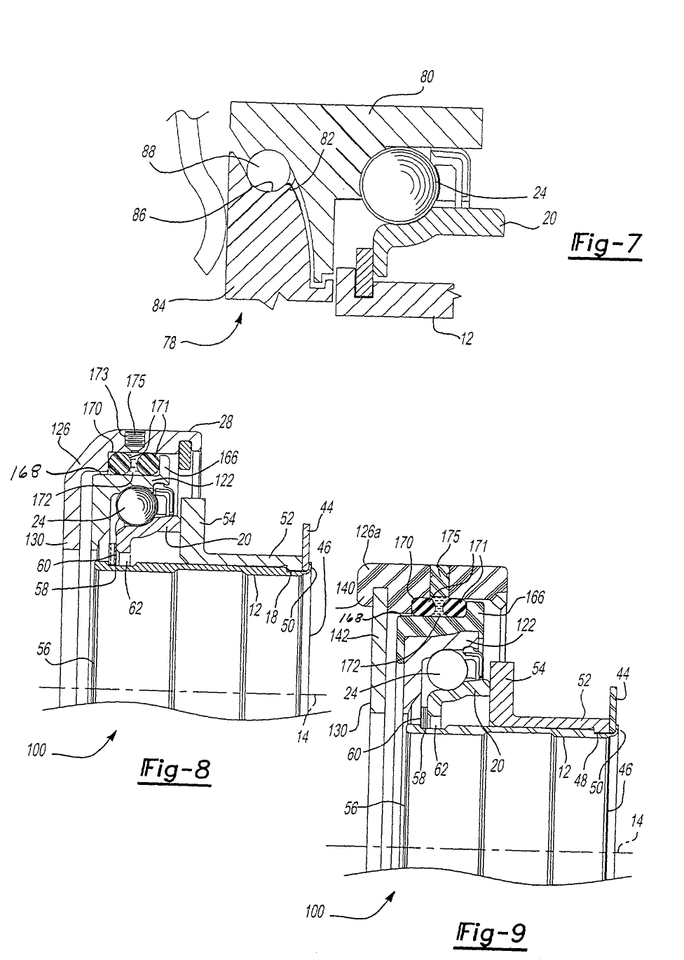

A second preferred embodiment of the present invention, shown in FIG. 7 and designated as reference numeral 78, includes an aligning ring 84 that rests within a rotatable race 80. Referring to FIG. 7, a clutch release bearing 78 similar to the first preferred embodiment 10 is shown. The second preferred embodiment 78 also includes a clearance fit between the aligning ring 84 and the rotatable race 80. However, the rotatable race 80 of the second preferred embodiment 78 extends outward and includes a contoured inner surface 82 forming a dish-like aperture. The aligning ring 84 of the second preferred embodiment 78 is circular and flat with a contoured outer diameter 86 corresponding to the contoured inner surface 82 of the rotatable race 80.

An elastomeric device is located between the contoured surfaces 82, 86 of the aligning ring 84 and the rotatable race 80 and is held therebetween. Preferably, the elastomeric device is a solid o-ring 88 made from Nitrile or some other suitable elastomer. The o-ring 88 extends around the outer diameter 86 of the rotatable race 80 and provides support for the aligning ring 84 thereon. Similar to the first preferred embodiment 10, if uneven loading occurs on the front face 30 of the aligning ring 84, then the o-ring 88 will compress at the point of higher loading, and allow the front face 30 of the aligning ring 84 to displace angularly away from being perfectly perpendicular to the central axis 14 of the bearing carrier 12.

A third preferred embodiment is shown in FIG. 8 and is designated as reference numeral 100. In the third preferred embodiment 100, the rotatable race 122 includes a support ring 166 that can be either press fit, molded onto or machined within an outer diameter 168 of the rotatable race 122. The aligning ring 126 fits over the rotatable race 122. There is a clearance fit between the aligning ring 126 and the rotatable race 122. An inner surface of the aligning ring 126 includes a contoured contact surface 170, and a pair of o-rings 171 are disposed between the contoured surface 170 of the aligning ring 126 and the support ring 166 that is mounted onto the rotatable race 122. The pair of o-rings 171 are disposed at a distance from each other, thereby forming a cavity 172 defined by the interior surface of the aligning ring 126, the outer diameter 168 of the rotatable race 122 and the pair of o-rings 171. A fluid fills the cavity 172, thereby forming a hydraulic chamber. Preferably, the pair of o-rings 171 are made from Nitrile or some other suitable elastomer. The o-rings 171 extend around the outer diameter of the support ring 166 of the rotatable race 122 and the fluid that is disposed within the cavity provides support for the aligning ring 126 thereon.

Preferably, the aligning ring 126 also includes a plurality of orifices 173 extending therethrough to allow access to the cavity 172, each of the orifices 173 includes a plug 175 to seal the orifices 173. The plugs can be either threadingly engaged within the orifices 173, press fit within the orifices 173, or secured by other suitable methods. It is to be understood, that the present invention could be practiced without the presence of orifices 173, wherein the cavity is accessed by a hallow needle type device such as a hypodermic needle that is inserted between the aligning ring 126 and one of the o-rings 171.

If uneven loading occurs on the front face 130 of the aligning ring 126, then the fluid within the cavity 172 will shift and allow the front face 30 of the aligning ring 126 to displace angularly away from being perfectly perpendicular to the central axis 14 of the bearing carrier 12.

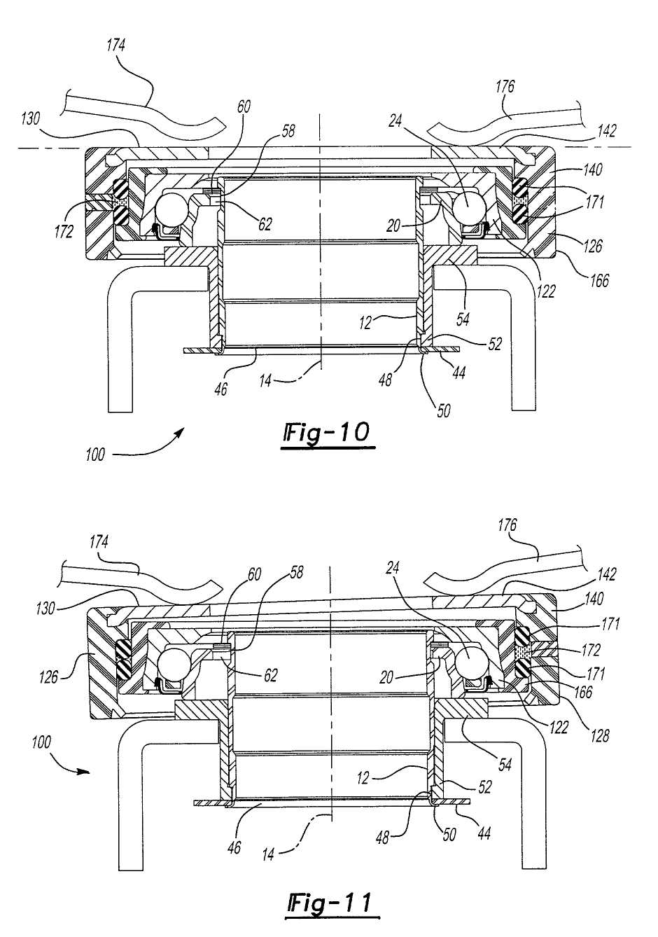

Referring to FIG. 10, when the aligning ring 126 comes into contact with an uneven spring plate, the fluid will shift to one side of the aligning ring 126 to allow the aligning ring 126 to tilt, thereby evening out the load over the front face 130 of the aligning ring 126.

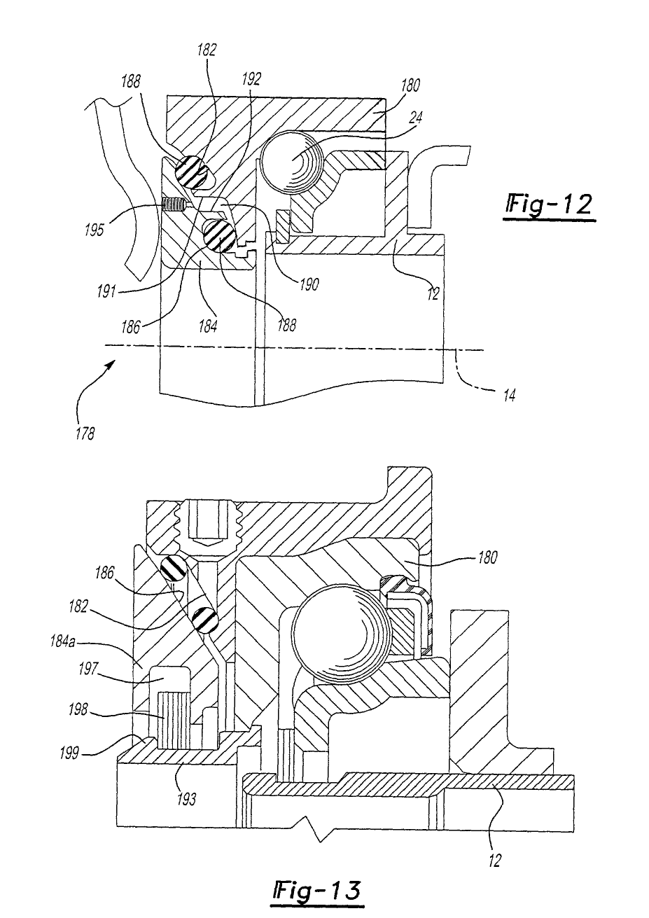

Referring to FIG. 11, a first finger 174 of the spring plate contacts the front face 130 of the aligning ring 126 before a second finger 176. When the first finger 174 contacts, the fluid supporting the side of the aligning ring 126 that the first finger 174 comes into contact with shifts. After the second finger 176 has come into contact with the aligning ring 126, there is even loading over the entire surface of the front face 130 of the aligning ring 126.

Additionally, the aligning ring 126 can be either one piece, as shown in FIG. 8, or two piece. Referring to FIG. 9, a two piece aligning ring 126a can be made from steel and a polymeric plastic material such as Nylon. The two piece aligning ring 126a includes an outer ring portion 140, and a frontal portion 142. Preferably, the frontal portion 142 is made from steel, and the outer ring portion 140 is made from Nylon. It is to be understood, that the outer ring portion 140 and the frontal portion 142 could be made from other suitable materials. Preferably, the outer ring portion 140 is molded onto the frontal portion 142, however the frontal portion 142 and the outer ring portion 140 could be attached to each other by other methods such as press fitting the two components 140, 142 together.

A fourth preferred embodiment, shown in FIG. 12 and designated as reference numeral 178, includes an aligning ring 184 that rests within a rotatable race 180. Referring to FIG. 12, the fourth preferred embodiment 178 also includes a clearance fit between the aligning ring 184 and the rotatable race 180. However, the rotatable race 180 of the fourth preferred embodiment 178 extends outward and includes a contoured inner surface 182 forming a dish-like aperture. An aligning ring 184 of the fourth preferred embodiment 178 is circular and flat with a contoured outer diameter 186 corresponding to the contoured inner surface 182 of the rotatable race 180. A pair of o-rings 188 are placed between the contoured surfaces 182, 186 of the aligning ring 184 and the rotatable race 180 and held therebetween. Preferably, the o-rings 188 are made from Nitrile or some other suitable elastomer. The pair of o-rings 188 are disposed at a distance from each other, thereby forming a cavity 190 defined by the outer surface of the aligning ring 184, the inner surface of the rotatable race 180 and the pair of o-rings 188.

Preferably the contoured surfaces 182, 186 of the aligning ring 184 and the rotatable race 180 include a pair of extending walls 191, 192 to provide an inertia track for the fluid held therein. The presence of the inertia track will guide the fluid within the cavity 190, thereby providing dampening to the movement of the aligning ring 184 as the fluid shifts from one side of the cavity 190 to the other when the aligning ring 184 experiences mis-alignment. It is to be understood, that the present invention can be practiced with or without the presence of the extending walls 191, 192.

A fluid fills the cavity 190, thereby forming a hydraulic chamber. The o-rings 188 extend around the outer surface 186 of the aligning ring 184 and the fluid that is disposed within the cavity 190 provides support for the aligning ring 184 thereon. The aligning ring 184 also includes a plurality of orifices 194 extending therethrough to allow access to the cavity 190, each of the orifices 194 including a plug 195 to seal the orifices 194. The plugs can be either threadingly engaged within the orifices 194, press fit within the orifices 194, or secured by other suitable methods

The o-rings 188 and fluid extend around the inner surface 182 of the rotatable race 180 and provide support for the aligning ring 184 thereon. Similar to the third preferred embodiment 100, if uneven loading occurs on the front face 130 of the aligning ring 184, then the fluid will shift at the point of higher loading, and allow the front face 130 of the aligning ring 184 to displace angularly away from being perfectly perpendicular to the central axis 14 of the bearing carrier 12.

Referring to FIG. 13, the fourth embodiment of the present invention is shown with an aligning ring 184a which can accommodate some radial movement relative to the central axis of the bearing carrier 12. As shown, the assembly includes a support hub 193 mounted onto the rotatable race 180 which is adapted to support the aligning ring 184a. The aligning ring 184a includes central bore with a channel 197 for receiving a snap ring 198, and the support hub 193 includes an annular lip 199 which engages the snap ring 198 to secure the aligning ring 184a onto the support hub 193. Preferably the snap ring 198 is a spring washer having a plurality of layers of a helically wound serpentine strip of resilient material. The spring washer provides axial force against the annular lip 199 of the support hub 193 to keep the aligning ring 184a held firmly in place adjacent the contoured inner surface 182 of the rotatable race 180.

Preferably the aligning ring 184a has an inner diameter that is larger than the outer diameter of the support hub 193 leaving a gap therebetween. This radial gap between the inner diameter of the aligning ring 184a and the outer diameter of the support hub 193 provides a clearance to allow the aligning ring 184a to shift radially relative to the bearing carrier 12. The amount of clearance between the inner diameter of the aligning ring 184a and the outer diameter of the support hub 193 determines how far the aligning ring 184a can shift. Additionally, it is to be understood that the aligning rings of the first, second and third embodiments could also be adapted to allow radial shifting relative to the bearing carrier.

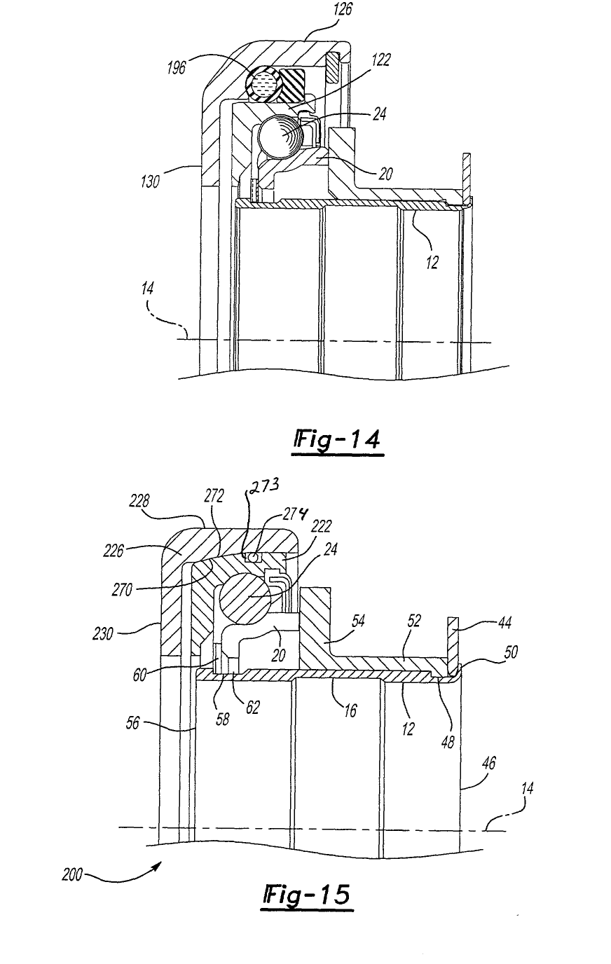

Although the third and fourth preferred embodiments 100, 178 include a pair of o-rings 171, 188 disposed at a distance between the aligning ring 126, 184 and the rotatable race 122, 180 to provide a hydraulic cavity 172, 190 wherein the fluid within the cavity 172, 190 can shift from one side of the aligning ring 126, 184 to allow the aligning ring 126, 184 to rotate angularly with respect to the bearing carrier 12, it is to be understood that the scope of the invention could include any device which would hold a body of fluid and allow the body of fluid to shift between the aligning ring 126, 184 and the rotatable race 122, 180 such as a fluid filled bladder 196 or an equivalent device as shown in FIG. 14.

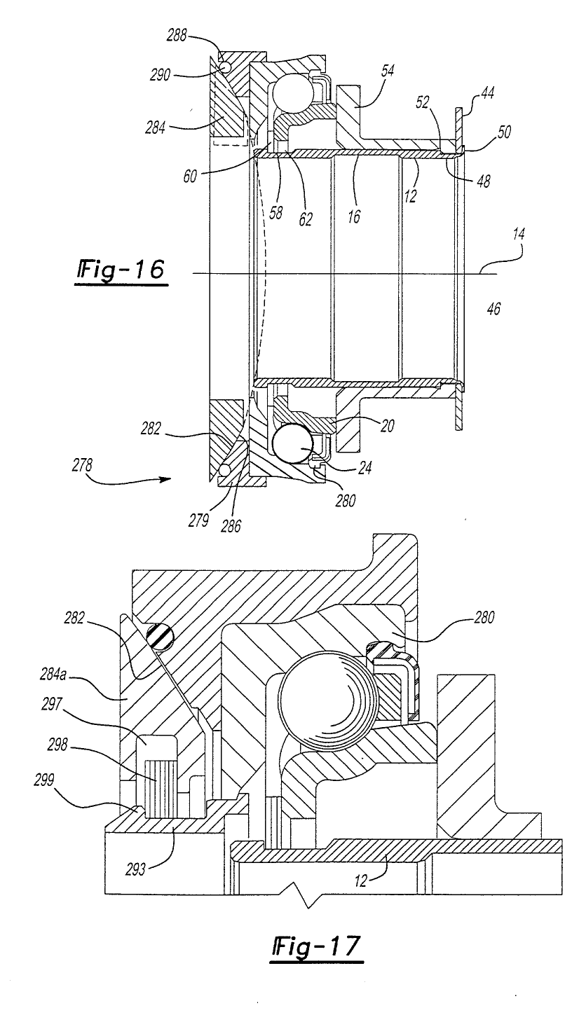

A fifth preferred embodiment is shown in FIG. 15 and designated as reference numeral 200. In the fifth preferred embodiment 200, the aligning ring 226 fits over the rotatable race 222. An inner surface of the aligning ring 226 includes a concave spherical contact surface 270. The rotatable race 222 includes a convex spherical surface 272 that corresponds to the concave spherical surface 270 of the aligning ring 226. Preferably, the spherical surface 272 of the rotatable race 222 includes a groove 273 for receiving an o-ring 274. The o-ring 274 helps to retain a lubricant that is placed between the aligning ring 226 and the rotatable race 222. Alternatively, the invention can be practiced without the presence of the o-ring 274, wherein the groove 273 will act as a reservoir for retaining a lubricant that will assist relative movement between the spherical surfaces 270, 272. It is to be understood, that the present invention could be practiced without the presence of the groove 273.

If uneven loading occurs on the front face 230 of the aligning ring 226, then the spherical surface 270 of the aligning ring 226 will slide on the spherical surface 272 of the rotatable race 222, allowing the front face 230 of the aligning ring 226 to displace angularly away from being perfectly perpendicular to the central axis 14 of the bearing carrier 12. When the aligning ring 226 comes into contact with an uneven spring plate, the aligning ring 226 will tilt, thereby evening out the load over the front face 230 of the aligning ring 226.

A sixth preferred embodiment, shown in FIG. 16 and designated as reference numeral 278, includes a support ring 279 that is mounted onto a rotatable race 280. An aligning ring 284 rests within the support ring 279. Referring to FIG. 15, the sixth preferred embodiment 278 also includes corresponding spherical surfaces on the aligning ring 284 and the support ring 279 of the rotatable race 280. However, the support ring 279 of the sixth preferred embodiment 278 extends outward and includes a concave spherical surface 282 forming a dish-like aperture. The aligning ring 284 of the sixth preferred embodiment 278 is circular and flat with a convex spherical outer diameter 286 corresponding to the concave spherical surface 282 of the support ring 279. Preferably, the support ring 279 includes a groove 288 within the concave spherical surface 282 for receiving an o-ring 290. The o-ring 290 helps to retain a lubricant that is placed between the aligning ring 284 and the support ring 279. Alternatively, the present invention can be practiced without the presence of the o-ring 290, wherein the groove 288 will act as a reservoir for retaining a lubricant that will assist relative movement between the spherical surfaces 282, 286. It is to be understood, that the present invention could be practiced without the presence of the groove 288.

Alternatively, the fifth and sixth embodiments 200, 278 could include a plurality of anti-friction elements (not shown) disposed between the concave and convex surfaces 270, 272, 282, 286 in order to assist in relative motion between the aligning ring 284 and the rotatable race 280. Additionally, the fifth and sixth preferred embodiments could also include an aligning ring adapted for radial movement relative to the bearing carrier. Referring to FIG. 17, the sixth preferred embodiment of the present invention is shown with an aligning ring 284a adapted to accommodate limited radial movement as discussed above. As shown, the assembly includes a support hub 293 mounted onto the rotatable race 280 which is adapted to support the aligning ring 284a. The aligning ring 284a includes a central bore with a channel 297 for receiving a snap ring 298, and the support hub 293 includes an annular lip 299 which engages the snap ring 298 to secure the aligning ring 284a onto the support hub 293. Preferably the snap ring 298 is a spring washer having a plurality of layers of a helically wound serpentine strip of resilient material. The spring washer provides axial force against the annular lip 299 of the support hub 293 to keep the aligning ring 284a held firmly in place adjacent the contoured inner surface 282 of the rotatable race 280.

Preferably the aligning ring 284a has an inner diameter that is larger than the outer diameter of the support hub 293 leaving a gap therebetween. This radial gap between the inner diameter of the aligning ring 284a and the outer diameter of the support hub 293 provides a clearance to allow the aligning ring 184a to shift radially relative to the bearing carrier 12. The amount of clearance between the inner diameter of the aligning ring 284a and the outer diameter of the support hub 293 determines how far the aligning ring 284a can shift.

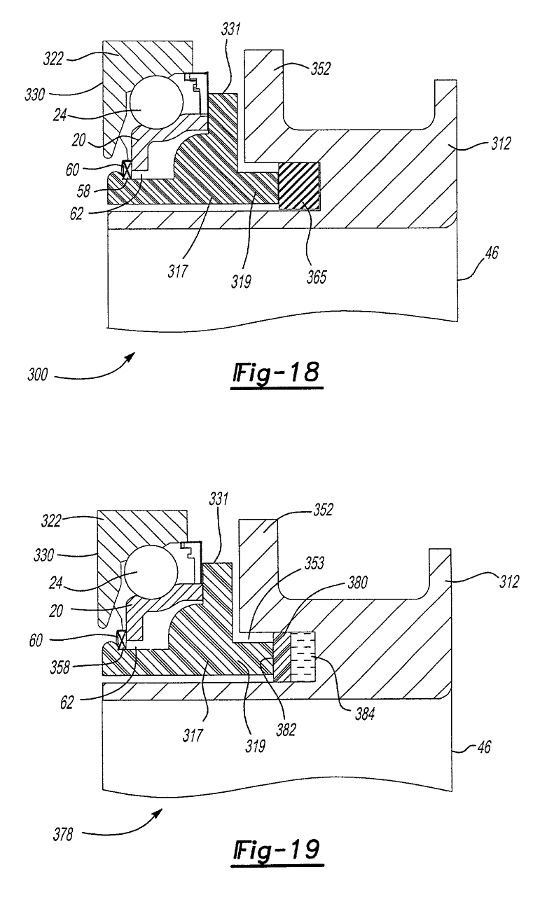

A seventh preferred embodiment is shown in FIG. 18 and designated as reference numeral 300. The seventh preferred embodiment 300 includes a bearing carrier 12 with a central axis 14. The bearing carrier 12 is a cylindrical tube which is preferably made from steel or nylon.

A first end 46 of the bearing carrier 12 includes a radially extending support flange 352 and an annular channel 353 extending within the support flange 352. A piston 317 is supported on the bearing carrier 12. The piston includes an annular ridge 319 extending into the annular channel 353. The piston 317 has an inner diameter and the bearing carrier 12 has an outer diameter such that there is a clearance fit between the bearing carrier 12 and the inner diameter of the piston 317. A bearing 18 is supported on the piston 317. The bearing 18 includes a stationary race 20, a rotatable race 322 and a plurality of anti-friction elements 24 disposed between the stationary race 20 and the rotatable race 322 to support the rotatable race 322 and to allow rotational movement of the rotatable race 322 with respect to the stationary race 20. The stationary race 20 does not rotate with respect to the bearing carrier 12, therefore the rotatable race 322 rotates relative to the bearing carrier 12.

Preferably, the rotatable race 322 of the seventh preferred embodiment includes a front face 330 adapted to provide a contact surface for the fingers of the spring plate 32. In this instance, the fingers of the spring plate 32 rest directly upon the front face 330 of the rotatable race 322. However, the rotatable race 322 could also include a support ring (not shown) mounted thereon to provide a contact surface for the fingers.

The bearing is mounted to the piston 317 in a manner that will allow the bearing to shift radially with respect to the piston 317 and therefore, the bearing carrier 12. In the seventh preferred embodiment 300, the piston 317 includes a support flange 331 extending radially about the piston 317 and the stationary race 20 rests upon a top surface of the support flange 331. The piston 317 includes a snap ring groove 358 extending radially around the outer diameter of the piston 317 for receiving a snap ring 60. The stationary race 20 is positioned between the snap ring 60 and the support flange 331 of the piston 317. Preferably, the snap ring 60 is a spring washer having a plurality of layers of a helically wound serpentine strip of resilient material. The spring washer provides axial force against the stationary race 320 to keep the stationary race 320 held tightly against the support flange 331 of the piston 317.

The stationary race 20 has an inner diameter that is larger than the outer diameter of the piston 317, leaving a gap 62 therebetween. This radial gap 62 between the inner diameter of the stationary race 20 and the outer diameter of the piston 317 provides a clearance to allow the stationary race 20 to shift radially relative to the piston 317. The amount of clearance between the inner diameter of the stationary race 20 and the outer diameter of the piston 317 determines how far the stationary race 20 can shift. The rotatable race 322 is rotatably connected to the stationary race 20, and the support ring, if present, is attached to the rotatable race 322, therefore, the support ring is allowed to shift radially relative to the bearing carrier 12 as the stationary race 20 shifts.

In the seventh preferred embodiment 300, the annular channel 353 includes a ring 365 of elastomeric material disposed within the annular channel 353 to interconnect and support the piston 317 on the bearing carrier 312. Preferrably the ring 365 of elastomeric material is made from Nitrile or some other suitable elastomer. If uneven loading occurs on the front face 330 then the ring 365 of elastomeric material will compress at the point of higher loading, and allow the front face 330 to displace angularly away from being perfectly perpendicular to the central axis 14 of the bearing carrier 312. When the aligning ring comes into contact with an uneven spring plate, the elastomeric ring 365 will compress at the point of higher loading to allow the piston 317 to tilt, thereby allowing the front face 330 to tilt, and evening out the load. Preferably, the annular ridge 319 of said piston 317 is operatively connected to said ring 365 of elastomeric material to prevent the annular ridge 319 from moving radially with respect to the ring 365 of elastomeric material, thereby maintaining radial positioning of the annular ridge 319 within the annular channel 353.

An eighth preferred embodiment is shown in FIG. 19 and is designated as reference numeral 378. Referring to FIG. 17, the eighth preferred embodiment 378 is similar to the seventh preferred embodiment 300 described above. However, the piston 317 of the eighth preferred embodiment 378 further includes a seal 380 mounted to the distal end 382 of the annular ridge 319 of the piston 317. The seal 380 engages the inner walls of the annular channel 353 of the bearing carrier 312 to create a sealed cavity 384. No elastomeric ring is placed within the annular channel 353, rather a fluid is placed within the cavity 384 to create a hydraulic chamber.

If uneven loading occurs on the front face 330, then the fluid within the cavity 384 will shift and allow the piston 317 to tilt, thereby allowing the front face 330 to displace angularly away from being perfectly perpendicular to the central axis of the bearing carrier 312. When the front face 330 comes into contact with an uneven spring plate, the fluid will shift to one side of the cavity 384 to allow the front face 330 to tilt, thereby evening out the load. Preferably, the annular ridge 319 of the piston 317 is operatively connected to the seal 380 to prevent the annular ridge 319 from moving radially with respect to the seal 380, thereby maintaining radial positioning of the annular ridge 319 within the annular channel 353.

The foregoing discussion discloses and describes several preferred embodiments of the invention. One skilled in the art will readily recognize from such discussion, and from the accompanying drawings and claims, that changes and modifications can be made to the invention without departing from the true spirit and fair scope of the invention as defined in the following claims.

1. A clutch release bearing assembly adapted to engage a spring plate of a clutch assembly of a motor vehicle manual transmission to either push or pull the spring plate to release the clutch of the manual transmission, said clutch release assembly comprising:
a bearing carrier defining a central axis;
a bearing assembly supported on said bearing carrier, said bearing assembly including a stationary race, a rotatable race and a plurality of anti-friction elements disposed between said stationary race and said rotatable race adapted to support said rotatable race and to allow rotational movement of said rotatable race with respect to said stationary race; and
an aligning ring including a radial outer diameter and a front face mounted to said rotatable race, said aligning ring adapted for engagement with the spring plate of the clutch assembly;
said front face of said aligning ring defining a plane that is normal to the axis of said bearing carrier, said aligning ring and said bearing being adapted to allow limited angular displacement of said front face away from normal relative to said central axis of said bearing carrier.

2. The clutch release bearing assembly of claim 1 wherein said bearing assembly has an inner diameter and said bearing carrier has an outer diameter, said inner diameter and said outer diameter being sized such that there is a clearance fit between said bearing assembly and said bearing carrier to allow limited radial shifting of said bearing assembly with respect to said central axis of said bearing carrier.

3. The clutch release bearing assembly of claim 1 wherein said aligning ring is mounted to said bearing assembly and adapted to allow limited radial displacement of said aligning ring relative to said central axis of said bearing carrier.

4. The clutch release bearing assembly of claim 3 further including a support hub mounted to said rotatable race, wherein said aligning ring includes a central bore adapted to be supported on said support hub, said aligning ring having an inner diameter and said bearing carrier having an outer diameter, said inner diameter and said outer diameter being sized such that there is a clearance fit between said aligning ring and said support hub to allow limited radial shifting of said aligning ring with respect to said central axis of said bearing carrier.

5. The clutch release bearing assembly of claim 1 including an elastomeric device disposed between said aligning ring and said bearing carrier to support said aligning ring and to allow limited angular displacement of said front face of said aligning ring away from normal relative to said central axis of said bearing carrier.

6. The clutch release bearing assembly of claim 5 wherein said elastomeric device is a solid o-ring disposed between said aligning ring and said rotatable race.

7. The clutch release bearing assembly of claim 6 wherein said o-ring is made from Nitrile.

8. The clutch release bearing assembly of claim 1 wherein said bearing carrier includes a first end and a second end, a first snap ring groove extending radially about said outer diameter adjacent said first end, a first snap ring disposed within said first snap ring groove, a washer attached to said second end and a support sleeve extending over said bearing carrier adjacent said washer, wherein said stationary race is disposed between said support sleeve and said first snap ring and thereby held in a fixed axial position.

9. The clutch release bearing assembly of claim 8 wherein said first snap ring is a spring washer having a plurality of layers of a helically wound serpentine strip of resilient material.

10. The clutch release bearing assembly of claim 1 including a hydraulic chamber having a fluid disposed therein located between said aligning ring and said bearing carrier to support said aligning ring and to allow limited angular displacement of said front face of said aligning ring away from normal relative to said central axis of said bearing.

11. The clutch release bearing assembly of claim 10 wherein said hydraulic chamber comprises a pair of o-rings disposed between said aligning ring and said rotatable race at a distance from each other, thereby forming a cavity defined by an interior surface of said aligning ring, an outer surface of said support ring and said pair of o-rings; and a fluid disposed within said cavity.

12. The clutch release bearing assembly of claim 11 wherein said aligning ring includes a plurality of orifices extending therethrough to allow access to said cavity to inject or remove said fluid, each of said orifices further including a plug to seal said orifices.

13. The clutch release bearing assembly of claim 10 wherein said hydraulic chamber is a fluid filled bladder disposed between said aligning ring and said rotatable race.

14. The clutch release bearing assembly of claim 1 wherein said rotatable race has a spherical face and said aligning ring has a spherical face, said spherical face of said rotatable race engaging said spherical face of said aligning ring to allow limited angular displacement of the front face away from normal relative to the axis of said bearing.

15. The clutch release bearing assembly of claim 14 wherein said rotatable race includes an oil groove extending radially about said rotatable race to retain a lubricant that reduces the friction between said rotatable race and said aligning ring.

16. The clutch release bearing assembly of claim 14 wherein said rotatable race includes a groove extending radially about said rotatable race adapted to receive an o-ring.

17. The clutch release bearing assembly of claim 14 including a plurality of anti-friction elements disposed between said rotatable race and said aligning ring.

18. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race;
an aligning ring including a radial outer diameter and a front face mounted to said rotatable race, said aligning ring adapted for engagement with a spring plate of a clutch assembly;
said front face of said aligning ring defining a plane that is normal to said central axis of said bearing carrier, said assembly including an elastomeric device disposed between said aligning ring and said bearing carrier to support said aligning ring and to allow limited angular displacement of said front face of said aligning ring away from normal relative to said central axis of said bearing carrier.

19. The clutch release bearing assembly of claim 18 wherein said bearing assembly has an inner diameter and said bearing carrier has an outer diameter, said inner diameter and said outer diameter being sized such that there is a clearance fit between said bearing assembly and said bearing carrier to allow limited radial shifting of said bearing assembly with respect to said central axis of said bearing carrier.

20. The clutch release bearing assembly of claim 18 wherein said elastomeric device is a solid o-ring disposed between said aligning ring and said rotatable race.

21. The clutch release bearing assembly of claim 20 wherein said o-ring is made from Nitrile.

22. The clutch release bearing assembly of claim 18 wherein said bearing carrier includes a first end and a second end, a first snap ring groove extending radially about said outer diameter adjacent said first end, a first snap ring disposed within said first snap ring groove, a washer attached to said second end and a support sleeve extending over said bearing carrier adjacent said washer, wherein said stationary race is disposed between said support sleeve and said first snap ring and thereby held in a fixed axial position.

23. The clutch release bearing assembly of claim 22 wherein said first snap ring is a spring washer having a plurality of layers of a helically wound serpentine strip of resilient material.

24. The clutch release bearing assembly of claim 18 wherein said aligning ring is mounted to said bearing assembly to allow limited radial displacement of said aligning ring relative to said central axis of said bearing carrier.

25. The clutch release bearing assembly of claim 19 further including a support hub mounted to said rotatable race, wherein said aligning ring includes a central bore adapted to be supported on said support hub, said aligning ring having an inner diameter and said bearing carrier having an outer diameter, said inner diameter and said outer diameter being sized such that there is a clearance fit between said aligning ring and said support hub to allow limited radial shifting of said aligning ring with respect to said central axis of said bearing carrier.

26. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race; and
an aligning ring including a radial outer diameter and a front face mounted to said rotatable race, said aligning ring adapted for engagement with a spring plate of a clutch assembly;
said front face of said aligning ring defining a plane that is normal to said central axis of said bearing carrier, said assembly including a pair of o-rings disposed between said aligning ring and said rotatable race at a distance from each other, thereby forming a hydraulic chamber defined by an interior surface of said aligning ring, an outer surface of said support ring and said pair of o-rings, and a fluid disposed within said hydraulic chamber to allow limited angular displacement of said front face of said aligning ring away from normal relative to said central axis of said bearing carrier.

27. The clutch release bearing assembly of claim 26 wherein said bearing assembly has an inner diameter and said bearing carrier has an outer diameter, said inner diameter and said outer diameter being sized such that there is a clearance fit between said bearing assembly and said bearing carrier to allow limited radial shifting of said bearing assembly with respect to said central axis of said bearing carrier.

28. The clutch release bearing assembly of claim 26 wherein said aligning ring includes a plurality of orifices extending therethrough to allow access to said hydraulic chamber to inject or remove said fluid, each of said orifices further including a plug to seal said orifices.

29. The clutch release bearing assembly of claim 26 wherein said bearing carrier includes a first end and a second end, a first snap ring groove extending radially about said outer diameter adjacent said first end, a first snap ring disposed within said first snap ring groove, a washer attached to said second end and a support sleeve extending over said bearing carrier adjacent said washer, wherein said stationary race is disposed between said support sleeve and said first snap ring and thereby held in a fixed axial position.

30. The clutch release bearing assembly of claim 29 wherein said first snap ring is a spring washer having a plurality of layers of a helically wound serpentine strip of resilient material.

31. The clutch release bearing assembly of claim 26 wherein said aligning ring is mounted to said bearing assembly to allow limited radial displacement of said aligning ring relative to said central axis of said bearing carrier.

32. The clutch release bearing assembly of claim 31 further including a support hub mounted to said rotatable race, wherein said aligning ring includes a central bore adapted to be supported on said support hub, said aligning ring having an inner diameter and said bearing carrier having an outer diameter, said inner diameter and said outer diameter being sized such that there is a clearance fit between said aligning ring and said support hub to allow limited radial shifting of said aligning ring with respect to said central axis of said bearing carrier.

33. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race; and
an aligning ring including a radial outer diameter and a front face mounted to said rotatable race, said aligning ring adapted for engagement with a spring plate of a clutch assembly;
said front face of said aligning ring defining a plane that is normal to said central axis of said bearing carrier, said assembly including a fluid filled bladder disposed between said aligning ring and said rotatable race to allow limited angular displacement of said front face of said aligning ring away from normal relative to said central axis of said bearing carrier.

34. The clutch release bearing assembly of claim 33 wherein said bearing assembly has an inner diameter and said bearing carrier has an outer diameter, said inner diameter and said outer diameter being sized such that there is a clearance fit between said bearing assembly and said bearing carrier to allow limited radial shifting of said bearing assembly with respect to said central axis of said bearing carrier.

35. The clutch release bearing assembly of claim 33 wherein said bearing carrier includes a first end and a second end, a first snap ring groove extending radially about said outer diameter adjacent said first end, a first snap ring disposed within said first snap ring groove, a washer attached to said second end and a support sleeve extending over said bearing carrier adjacent said washer, wherein said stationary race is disposed between said support sleeve and said first snap ring and thereby held in a fixed axial position.

36. The clutch release bearing assembly of claim 35 wherein said first snap ring is a spring washer having a plurality of layers of a helically wound serpentine strip of resilient material.

37. The clutch release bearing assembly of claim 33 wherein said aligning ring is mounted to said bearing assembly to allow limited radial displacement of said aligning ring relative to said central axis of said bearing carrier.

38. The clutch release bearing assembly of claim 37 further including a support hub mounted to said rotatable race, wherein said aligning ring includes a central bore adapted to be supported on said support hub, said aligning ring having an inner diameter and said bearing carrier having an outer diameter, said inner diameter and said outer diameter being sized such that there is a clearance fit between said aligning ring and said support hub to allow limited radial shifting of said aligning ring with respect to said central axis of said bearing carrier.

39. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race;
an aligning ring including a radial outer diameter and a front face mounted to said rotatable race, said aligning ring adapted for engagement with a spring plate of a clutch assembly;
said bearing assembly having an inner diameter and said bearing carrier having an outer diameter, said inner diameter and said outer diameter being sized such that there is a clearance fit between said bearing assembly and said bearing carrier to allow limited radial shifting of said bearing assembly with respect to said bearing carrier;
said front face of said aligning ring defining a plane that is normal to said central axis of said bearing carrier, said rotatable race having a spherical face and said aligning ring having a spherical face, said spherical face of said rotatable race engaging said spherical face of said aligning ring to allow limited angular displacement of the front face away from normal relative to said central axis of said bearing carrier.

40. The clutch release bearing assembly of claim 39 wherein said bearing assembly has an inner diameter and said bearing carrier has an outer diameter, said inner diameter and said outer diameter being sized such that there is a clearance fit between said bearing assembly and said bearing carrier to allow limited radial shifting of said bearing assembly with respect to said central axis of said bearing carrier.

41. The clutch release bearing assembly of claim 39 wherein said rotatable race includes a groove extending radially about said rotatable race to retain a lubricant that reduces the friction between said rotatable race and said aligning ring.

42. The clutch release bearing assembly of claim 39 wherein said rotatable race includes a groove extending radially about said rotatable race adapted to receive an o-ring.

43. The clutch release bearing assembly of claim 39 wherein said bearing carrier includes a first end and a second end, a first snap ring groove extending radially about said outer diameter adjacent said first end, a first snap ring disposed within said first snap ring groove, a washer attached to said second end and a support sleeve extending over said bearing carrier adjacent said washer, wherein said stationary race is disposed between said support sleeve and said first snap ring and thereby held in a fixed axial position.

44. The clutch release bearing assembly of claim 43 wherein said first snap ring is a spring washer having a plurality of layers of a helically wound serpentine strip of resilient material.

45. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race;
an aligning ring including a radial outer diameter and a front face mounted to said rotatable race, said front face of said aligning ring defining a plane that is normal to said central axis of said bearing carrier, said aligning ring adapted for engagement with a spring plate of a clutch assembly;
a plastic piston disposed between said bearing and said bearing carrier and supporting said bearing, said bearing carrier including an annular channel, and said plastic piston including an annular ridge disposed within said annular channel; and
a ring of elastomeric material disposed within said annular channel between said plastic piston and said bearing carrier for supporting said plastic piston and to allow limited angular displacement of said front face of said aligning ring away from normal relative to said central axis of said bearing carrier.

46. The clutch release bearing assembly of claim 45 wherein said bearing assembly has an inner diameter and said plastic piston has an outer diameter, said inner diameter and said outer diameter being sized such that there is a clearance fit between said bearing assembly and said plastic piston to allow limited radial shifting of said bearing assembly with respect to said central axis of said bearing carrier.

47. The clutch release bearing assembly of claim 45 wherein said annular ridge of said piston is operatively connected to said ring of elastomeric material to prevent said annular ridge from moving radially with respect to said ring of elastomeric material, thereby maintaining radial positioning of said annular ridge within said annular channel.

48. A clutch release bearing assembly adapted to engage a spring plate of a clutch assembly of a motor vehicle manual transmission to either push or pull the spring plate to release the clutch of the manual transmission, said clutch release assembly comprising:
a bearing carrier with a central axis;
a bearing assembly supported on said bearing carrier, said bearing assembly including a stationary race, a rotatable race and a plurality of anti-friction elements disposed between said stationary race and said rotatable race to support said rotatable race and to allow rotational movement of said rotatable race with respect to said stationary race;
an aligning ring including a radial outer diameter and a front face mounted to said rotatable race, said front face of said aligning ring defining a plane that is normal to said central axis of said bearing carrier, said aligning ring adapted for engagement with a spring plate of a clutch assembly;
a plastic piston disposed between said bearing and said bearing carrier and supporting said bearing, said bearing carrier including an annular channel, and said plastic piston including an annular ridge disposed within said annular channel; and
a seal mounted onto said annular ridge and engaging inner walls of said annular channel to form a cavity, and a fluid being disposed within said cavity to support said plastic piston and to allow limited angular displacement of said front face of said aligning ring away from normal relative to said central axis of said bearing carrier.

49. The clutch release bearing assembly of claim 48 wherein said bearing assembly has an inner diameter and said plastic piston has an outer diameter, said inner diameter and said outer diameter being sized such that there is a clearance fit between said bearing assembly and said plastic piston to allow limited radial shifting of said bearing assembly with respect to said central axis of said bearing carrier.

50. The clutch release bearing assembly of claim 48 wherein said annular ridge of said piston is operatively connected to said seal to prevent said annular ridge from moving radially with respect to said seal, thereby maintaining radial positioning of said annular ridge within said annular channel.
